(19) United States
(12) Patent Application Publication
(10) Pub. No.: US 2024/0423276 A1
(43) Pub. Date: Dec. 26, 2024

(54) HEATING DEVICE, ATOMIZATION ASSEMBLY, AND AEROSOL GENERATION DEVICE

(71) Applicant: VERDEWELL INTERNATIONAL HOLDINGS LIMITED, George Town (KY)

(72) Inventors: Lianhu XU, Shenzhen (CN); Yuanjian LI, Shenzhen (CN)

(21) Appl. No.: 18/745,095

(22) Filed: Jun. 17, 2024

(30) Foreign Application Priority Data
Jun. 26, 2023 (CN) 202310763367.8

(51) Int. Cl. A24F 40/46; H05B 3/40

(52) U.S. Cl. CPC A24F 40/46; H05B 3/40

(57) ABSTRACT

A heating device for heating an atomizable medium includes: a heating substrate, at least one closed cavity being formed in the heating substrate; and a vaporizable medium arranged in the at least one closed cavity. In an embodiment, the at least one closed cavity includes a vacuum cavity. In an embodiment, the vaporizable medium is at least one of dowtherm, mercury, cesium, or sulfur.

### CROSS-REFERENCE TO PRIOR APPLICATION

Priority is claimed to Chinese Patent Application No. 202310763367.8, filed on Jun. 26, 2023, the entire disclosure of which is hereby incorporated by reference herein.

### FIELD

The present invention relates to the field of atomization technologies, and more specifically, to a heating device, an atomization assembly, and an aerosol generation device.

### BACKGROUND

A heat-not-burn aerosol generation device generally uses a heating device in the form of a heating pot, a heating tube, a heating sheet, or the like to heat an atomizable medium, to release an aerosol extract in the atomizable medium in a non-burning state. An operating temperature of the heating device is usually in a range of 180° C. to 350° C.

During the heating, because a high-temperature heating device is in contact with a low-temperature atomizable medium and a structural member, temperature uniformity of the heating device cannot be maintained, and a large temperature difference exists in a contact position with an outside environment, which may cause the heated atomizable medium to be heated unevenly and atomization efficiency to be reduced. At the operating temperature of 300° C., even at a length of 2 cm, the temperature difference of a metallic heating device also reaches 20° C., and the temperature difference of a non-metallic heating device is not less than 60° C.

### SUMMARY

In an embodiment, the present invention provides a heating device for heating an atomizable medium, the heating device comprising: a heating substrate, at least one closed cavity being formed in the heating substrate; and a vaporizable medium arranged in the at least one closed cavity.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural diagram of an aerosol generation system according to some embodiments of the present invention.

FIG. 2 is a schematic diagram of a longitudinal cross-sectional structure of the aerosol generation system shown in FIG. 1.

FIG. 3 is a schematic diagram of a longitudinal cross-sectional structure of an atomization assembly in FIG. 2.

FIG. 4 is a schematic diagram of a longitudinal cross-sectional structure of a heating substrate in FIG. 3.

FIG. 5 is a schematic diagram of a breakdown structure of the atomization assembly shown in FIG. 3.

FIG. 6 is a schematic three-dimensional structural diagram of a heating device according to a first modified embodiment of the present invention.

FIG. 7 is a schematic three-dimensional structural diagram of a heating device according to a second modified embodiment of the present invention.

FIG. 8 is a schematic three-dimensional structural diagram of a heating device according to a third modified embodiment of the present invention.

FIG. 9 is a schematic three-dimensional structural diagram of a heating device according to a fourth modified embodiment of the present invention.

FIG. 10 is a schematic diagram of a longitudinal cross-sectional structure of the heating device shown in FIG. 9.

FIG. 11 is a schematic diagram of a longitudinal cross-sectional structure of an atomization assembly according to another embodiment of the present invention.

### DETAILED DESCRIPTION

In an embodiment, the present invention provides a heating device having high thermal conductivity and excellent isothermality, an atomization assembly having the heating device, and an aerosol generation device.

A technical solution adopted in the present invention to solve the technical problem is to construct a heating device. The heating device includes:

a heating substrate, where at least one closed cavity is formed in the heating substrate; and a vaporizable medium arranged in the at least one closed cavity.

In some embodiments, the at least one closed cavity includes a vacuum cavity.

In some embodiments, the vaporizable medium includes at least one of dowtherm, mercury, cesium, or sulfur.

In some embodiments, the heating device further includes a porous structure arranged in the at least one closed cavity.

In some embodiments, the porous structure includes a microporous structure or a micro-slotted structure with a capillary force.

In some embodiments, the heating device further includes a protective film arranged on a surface of the heating substrate.

In some embodiments, the heating substrate includes a first layer and a second layer arranged opposite to the first layer. A closed cavity is formed between the first layer and the second layer.

In some embodiments, the heating substrate is in the shape of a tube, a flake, or a column.

In some embodiments, the heating device further includes a heating element arranged on a surface of the heating substrate.

The present invention further provides an atomization assembly, including the heating device as described above and an atomization base arranged on an end of the heating device.

The present invention further includes an aerosol generation device, including a shell and an atomization assembly arranged in the shell.

Implementation of the present invention has at least the following beneficial effects. According to the present invention, a vapor-liquid phase change of the vaporizable medium is used to implement heat transfer, and a thermal resistance is very small. Therefore, the heating device may have extremely high thermal conductivity and excellent isothermality.

To provide a clearer understanding of the technical features, objectives, and effects of the present invention, specific implementations of the present invention are described with reference to the accompanying drawings. In the following description, numerous specific details are set forth to facilitate a thorough understanding of the present invention. However, the present invention may be implemented in many other manners different from those described herein. A person skilled in the art may make similar improvements without departing from the connotation of the present invention. Therefore, the present invention is not limited to the specific embodiments disclosed below.

In the description of the present invention, it should be understood that, orientation or position relationships indicated by terms such as “longitudinal”, “transverse”, “upper”, “lower”, “top”, “bottom”, “inner”, “outer”, are orientation or position relationships shown based on the accompanying drawings or orientation or position relationships that the product of the present invention is usually placed in use, and are merely used for describing the present invention and simplifying the description, rather than indicating or implying that the mentioned device or element needs to have a particular orientation or needs to be constructed and operated in a particular orientation. Therefore, such terms should not be construed as a limitation on the present invention.

In addition, terms “first” and “second” are merely for the purpose of description, and cannot be construed as indicating or implying relative importance or implicitly specifying a quantity of technical features indicated. Therefore, features defined with “first” and “second” may explicitly or implicitly include at least one of the features. In the description of the present invention, “a plurality of” means two, for example, two and three, unless otherwise explicitly and specifically defined.

In the present invention, unless otherwise clearly specified and defined, terms such as “mounting”, “connected”, “connection”, and “fixed” shall be understood in a broad sense. For example, the connection may be a fixed connection, a detachable connection, or an integral connection; or may be a mechanical connection, or an electrical connection; or may be a direct connection, an indirect connection through an intermediary, or internal communication between two elements or interaction between two elements, unless otherwise specified explicitly. A person of ordinary skill in the art may understand the specific meanings of the foregoing terms in the present invention based on specific situations.

In the present invention, unless otherwise explicitly specified and defined, the first feature being “on” or “above” or “below” or “under” the second feature may mean that the first feature and the second feature are in direct contact, or the first feature and the second feature are in indirect contact through an intermediary. In addition, the first feature being “on” or “above” the second feature may mean that the first feature is directly above or obliquely above the second feature, or may merely mean that a horizontal position of the first feature is higher than that of the second feature. The first feature being “below” or “under” the second feature may mean that the first feature is directly below or obliquely below the second feature, or may merely mean that the horizontal position of the first feature is lower than that of the second feature.

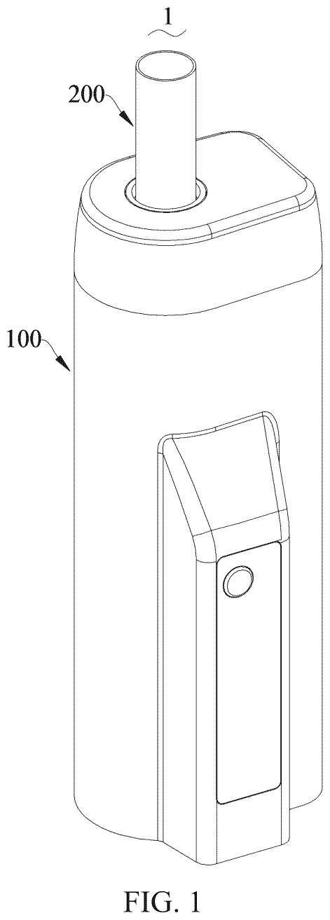

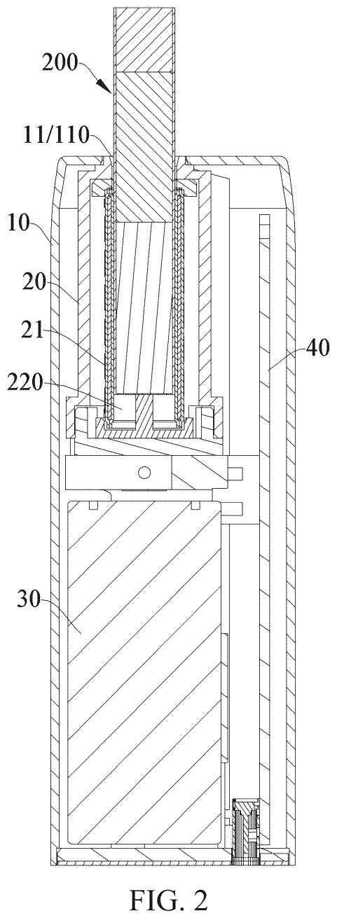

FIG. 1 and FIG. 2 show an aerosol generation system 1 according to some embodiments of the present invention. The aerosol generation system includes an aerosol generation device 100 and an atomizable medium 200 at least partially accommodated in the aerosol generation device 100. The aerosol generation device 100 is configured to generate heat after being energized to heat the atomizable medium 200 accommodated therein, and release an aerosol in the atomizable medium 200 in a non-burning state.

The atomizable medium 200 includes a solid smoke generating substrate for generating the aerosol upon heating. The solid smoke generating substrate may include one or more of a thread, a flake, a particle, powder, paste, and the like. In this embodiment, the atomizable medium 200 is in the shape of a cylinder and may be at least partially inserted into the aerosol generation device 100. Certainly, in another embodiment, the atomizable medium 200 is not limited to be in the shape of the circular column, or may be in another shape such as an elliptic cylinder or a columnar racetrack. In another embodiment, the atomizable medium 200 may also include a liquid substrate for generating the aerosol upon heating.

The aerosol generation device 100 includes a shell 10, an atomization assembly 20, a battery 30, and a circuit board 40. The atomization assembly 20, the battery 30, and the circuit board 40 are all accommodated in the shell 10. The circuit board 40 is respectively electrically connected to the atomization assembly 20 and the battery 30, and a relevant control circuit is arranged the circuit board. The control circuit is configured to control power supply from the battery 30 to the atomization assembly 20, and may further be configured to control a magnitude of power provided by the battery 30 to the atomization assembly 20.

An insertion port 11 is formed on a top wall of the shell 10. The atomizable medium 200 can be inserted into the shell 10 through the insertion port 11. A cross-sectional area of the insertion port 11 may be greater than a cross-sectional area of the atomizable medium 200, so that an air inlet gap 110 is formed between an outer surface of the atomizable medium 200 and an inner wall surface of the insertion port 11 when the atomizable medium 200 is inserted into the insertion port 11. The air inlet gap 110 may be configured for outside air to enter the shell 10. The air inflow manner may avoid formation of a hole on the shell 10. Certainly, in another embodiment, the cross-sectional area of the insertion port 11 may also be equal to or less than the cross-sectional area of the atomizable medium 200, and an inflow of air may be achieved by forming the hole on the shell 10.

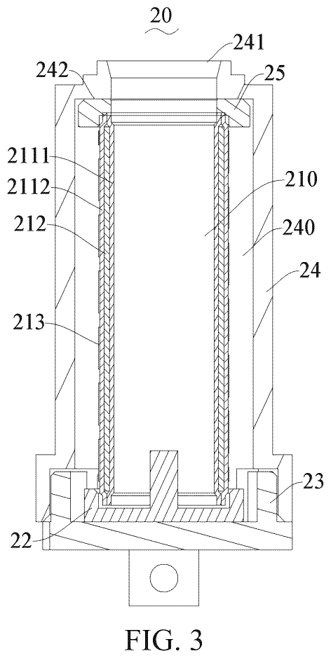

As shown in FIG. 2 and FIG. 3, the atomization assembly 20 includes a heating device 21. In this embodiment, the heating device 21 is in the shape of a circular tube, and an atomization cavity 210 configured to accommodate the atomizable medium 200 is formed therein. An opening 241 is formed at an upper end of the atomization assembly 20 close to the insertion port 11. The insertion port 11, the opening 241, and the atomization cavity 210 are successively in communication with each other from top to bottom in an axial direction of the atomizable medium 200, so as to facilitate the insertion of the atomizable medium 200.

Certainly, in another embodiment, the heating device 21 is not limited to be in the shape of a circular tube, or may be in another shape such as an elliptical tube or a racetrack-shaped tube. In another embodiment, the heating device 21 may also be in the shape of a flake or a column. The heating device 21 may be inserted into the atomizable medium 200 for heating. In still another embodiment, the heating device 21 may also be in the shape of a pot. The atomizable medium 200 is at least partially accommodated in the heating device 21 for heating.

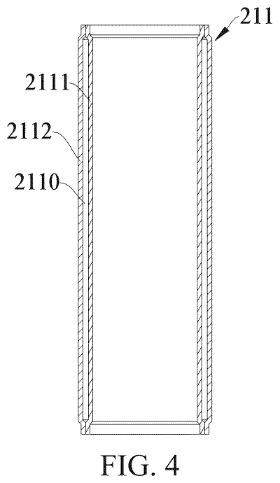

As shown in FIG. 3 and FIG. 4, the heating device 21 includes a heating substrate 211. A closed cavity 2110 is formed in the heating substrate 211. The closed cavity 2110 is filled with a vaporizable medium 212. During heating by the heating device 21, the vaporizable medium 212 can be vaporized into vapor. Heat is quickly and evenly transferred to all positions of an inner/outer wall of the heating substrate 211 through the vapor, so as to ensure a uniform temperature of all of the positions of the heating substrate 211. Since a vapor-liquid phase change of the vaporizable medium 212 is mainly used to implement heat transfer inside the heating device 21, and a thermal resistance is very small, the heating device may have extremely high thermal conductivity and excellent isothermality. In this way, it may be ensured that a temperature difference is less than 1° C. at a length of about 30 cm of the heating device 21, thereby avoiding a case of a uniform local temperature of the heating device 21.

The heating substrate 211 may be made of a metallic material (such as aluminum or stainless steel) or a non-metallic material (such as ceramic or quartz glass). The vaporizable medium 212 may include at least one of dowtherm (a eutectic mixture of biphenyl and diphenyl oxide), mercury, cesium, or sulfur, which has a low boiling point and is easy to volatilize.

Preferably, the closed cavity 2110 is a vacuum cavity (or a negative pressure cavity). Bad impurities in the closed cavity 2110 are removed by vacuumizing the closed cavity 2110 to ensure that the vaporizable medium 212 has a desirable operating environment. The closed cavity 2110 extends at least in the axial direction and/or a circumferential direction of the atomizable medium 200, so that the vaporizable medium 212 can transfer heat toward the axial direction and/or the circumferential direction of the atomizable medium 200.

In some embodiments, a porous structure may also be arranged in the closed cavity 2110. The porous structure may include a channel structure recessed on a cavity wall surface of the closed cavity 2110, or the porous structure may also include powder, particles, or wire mesh filling the closed cavity 2110. When the closed cavity 2110 is filled with powder, the powder needs to be sintered and fixed.

The porous structure is at least partially in communication with a low-temperature condensation area and a high-temperature evaporation area in the closed cavity 2110. When vapor formed by heating and evaporating the vaporizable medium 212 flows to the low-temperature condensation area with a low temperature, condensate is formed. The condensate can flow back to the high-temperature evaporation area with a high temperature along the porous structure to evaporate again, so that a circulation of airflow is more easily formed.

In some embodiments, the porous structure may include a microporous structure or a micro-slotted structure with a capillary force, and backflow of the vaporizable medium 212 is implemented through the capillary force. Certainly, in another embodiment, backflow of the vaporizable medium 212 may also be implemented by gravity. In this case, the porous structure may or may not have the capillary force.

Further, in some embodiments, the porous structure may be made of a material having good thermal conductivity (for example, a heat conductivity coefficient is greater than 150 W/m·K). For example, the porous structure may be a copper mesh formed by a process such as mechanical processing or laser processing, or may be formed by sintering copper powder. When the heating device 21 uses resistive heating, heat can be better transferred through the porous structure.

In some embodiments, the heating substrate 211 has a two-layer structure, which may include a first layer 2111 and a second layer 2112. The closed cavity 2110 is formed between the first layer 2111 and the second layer 2112. Specifically, in this embodiment, the first layer 2111 and the second layer 2112 are both in the shape of a circular tube and coaxially arranged. The second layer 2112 is sleeved outside the first layer 2111. Two axial ends of the first layer 2111 and the second layer 2112 may be sealed together by welding, adhesive bonding, or the like.

It may be understood that, in another embodiment, the heating substrate 211 may also have a three-layer or multi-layer structure. A closed cavity 2110 is formed between every two adjacent layers, so that a plurality of closed cavities 2110 may be formed in the heating substrate 211.

Further, a protective film may also be arranged on a surface of the heating substrate 211. When the heating substrate 211 is made of metal, the protective film may prevent a metal surface of the heating substrate 211 from directly contacting the atomizable medium 200, and prevent the heating substrate 211 from producing a metallic taste that affects an atomization taste of the atomizable medium 200. In some embodiments, a dense protective film may be formed on the surface of the heating substrate 211 through anodic oxidation or electrophoresis. In some other embodiments, a ceramic film may also be generated on an inner wall surface of the heating substrate 211 (that is, a wall surface of the first layer 2111 close to the atomization cavity 210) through vacuum deposition, and the like.

In an embodiment, steps of a manufacturing process of the heating device 21 are as follows:

S1: Provide tubes made of a high-ductility metal such as aluminum, iron, or steel as tubes of the first layer 2111 and the second layer 2112 of the heating substrate 211, where an outer diameter of the tube of the first layer 2111 is less than an inner diameter of the tube of the second layer 2112.

S2: Sleeve the tubes of the first layer 2111 and the second layer 2112 together, so that a cavity is formed between the first layer 2111 and the second layer 2112.

S3: Pre-roll and then seal an end of each of the tubes of the first layer 2111 and the second layer 2112 by welding, so as to seal an end of the cavity.

S4: Fill the cavity with a porous structure.

S5: Roll and then seal an other end of each of the tubes of the first layer 2111 and the second layer 2112 by welding, and reserve a vacuumizing port and a liquid filling port.

S6: Vacuumize the cavity through a specialized device, and fill the cavity with the vaporizable medium 212.

S7: Seal the vacuumizing port by using a jaw, and the like, and seal the filling port through welding, and the like, so that the cavity forms a fully sealed structure, thereby forming the closed cavity 2110.

S8: Generate an oxide film on the heating substrate 211 through anodic oxidation, or process a ceramic coating on the inner wall surface of the heating substrate 211.

The heating manner of the heating device 21 is not limited. For example, the heating device may adopt one or more of resistive heating, electromagnetic heating, infrared heating, and the like. In this embodiment, the heating device 21 adopts the resistive heating. The heating device 21 further includes a heating element 213 arranged on the inner wall surface or an outer wall surface of the heating substrate 211. Preferably, the heating element 213 is arranged on an outer wall surface of the second layer 2112, which is easy to process and form, and may prevent the heating element 213 from directly contacting the atomizable medium 200.

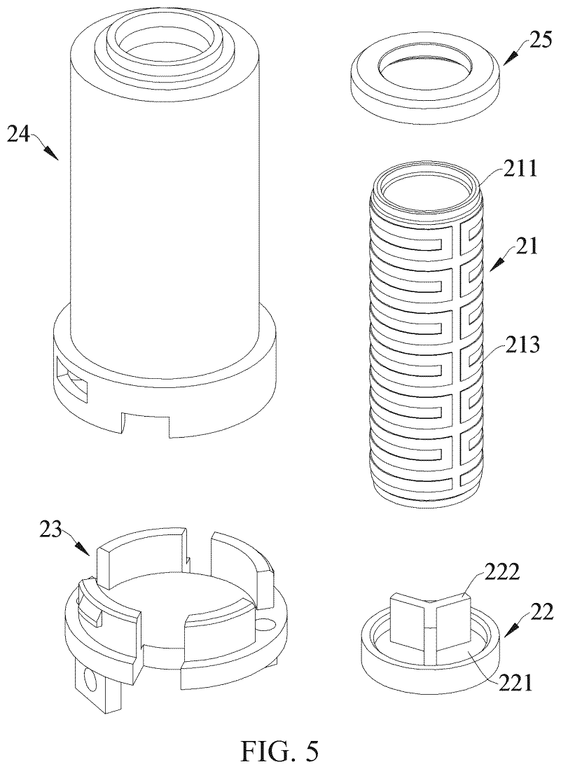

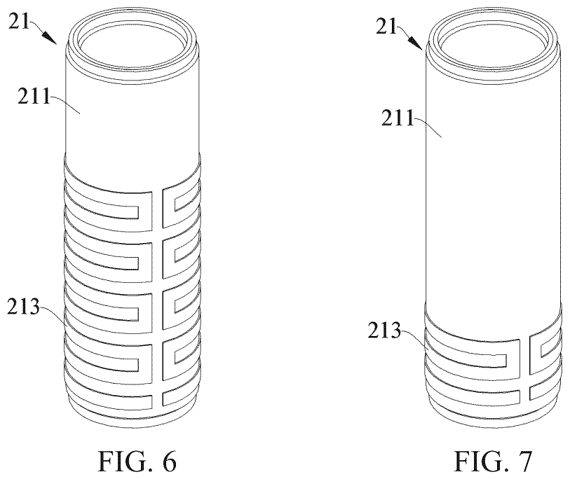

The heating element 213 may be a resistive heating film or a resistive heating wire, which may be arranged at any position in an axial direction and/or a circumferential direction of the heating substrate 211, and heat is rapidly transmitted to all positions of the heating substrate 211 through the vaporizable medium 212. In the embodiment shown in FIG. 5, the heating element 213 covers or substantially covers an entire axial position of the closed cavity 2110. In the first modified embodiment shown in FIG. 6, the heating element 213 covers most (for example, more than 60%) of the axial position of the closed cavity 2110. In the second modified embodiment shown in FIG. 7, the heating element 213 covers a small part (for example, 20% to 40%) of the axial position of the closed cavity 2110.

When the heating element 213 does not completely cover the entire axial position of the closed cavity 2110, preferably, the heating element 213 is correspondingly arranged at a lower part of the closed cavity 2110 (that is, a side away from the insertion port 11 in the axial direction), which facilitates the backflow of the vaporizable medium 212 by gravity.

In addition, the heating element 213 may include only one heating track, or may include at least two heating tracks connected in series or in parallel. The at least two heating tracks connected in series or in parallel may be spaced apart from each other in the axial direction and/or the circumferential direction of the heating substrate 211.

As shown in FIG. 2, FIG. 3, and FIG. 5, the atomization assembly 20 may further include an atomization base 22. The atomization base 22 is arranged at one end of the heating substrate 211 away from the opening 241, to cover a lower opening of the atomization cavity 210. In some embodiments, the atomization base 22 may include a base body 221 and a protruding stage 222 protruding from the base body 221 into the atomization cavity 210. When the atomizable medium 200 is mounted to the atomization cavity 210, a bottom surface of the atomizable medium 200 may abut against the protruding stage 222, and a gap between the bottom surface of the atomizable medium 200 and a top surface of the base body 221 forms an airflow channel 220 for circulation of airflow.

A vent gap may be formed between an outer wall surface of the atomizable medium 200 and an inner wall surface of the atomization cavity 210. During inhalation, outside air may enter the atomization cavity 210 through the air inlet gap 110, and then flow to the airflow channel 220 through the vent gap between the inner wall surface of the atomization cavity 210 and the outer wall surface of the atomizable medium 200, and enter the atomizable medium 200 from a bottom of the atomizable medium 200. Air can also be preheated when flowing through the vent gap, and the preheated air enters the atomizable medium 200, which can obtain a better heating atomization effect than cold air.

Certainly, in another embodiment, the atomization assembly 20 may also adopt another air inlet structure. For example, an air inlet hole may also be formed on the base body 221, so that the outside air directly enters the atomizable medium 200 through the air inlet hole on the base body 221.

In some embodiments, the atomization assembly 20 may further include a fixing tube 24 sleeved outside the heating substrate 211 and a fixing base 23 arranged at a lower end of the fixing tube 24. The fixing tube 24 may be in the shape of a circular tube with two open ends, and an upper end thereof is opened to form the opening 241. The fixing base 23 is arranged at the lower end of the fixing tube 24 and may be mutually fixed with the fixing tube 24 through engagement, or the like, which can support the atomization base 22 and the heating substrate 211. A gap 240 may be formed between an inner wall surface of the fixing tube 24 and the outer wall surface of the heating substrate 211, which facilitates heat insulation between the fixing tube 24 and the heating substrate 211.

An abutting surface 242 may be formed in the fixing tube 24. An upper end surface of the heating substrate 211 may directly or indirectly abut against the abutting surface 242, and a lower end surface of the heating substrate 211 abuts against the fixing base 23 through the atomization base 22, thereby realizing fixation of the heating substrate 211 within the fixing tube 24 in the axial direction. Specifically, in this embodiment, the upper end surface of the heating substrate 211 abuts against the abutting surface 242 through an annular seal gasket 25. The scal gasket 25 may be made of an elastic material such as silica gel, which can implement hermetic seal of the atomization cavity 210.

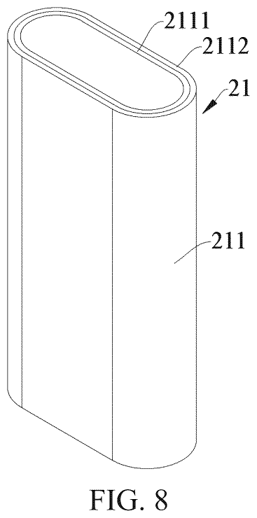

FIG. 8 shows a heating device 21 according to a third modified embodiment of the present invention. A heating substrate 211 in this embodiment is in the shape of a tubular racetrack, and a first layer 2111 and a second layer 2112 of the heating substrate 211 are both in the shape of a tubular racetrack and coaxially arranged. Correspondingly, a closed cavity 2110 formed between the first layer 2111 and the second layer 2112 is in the shape of an annular racetrack.

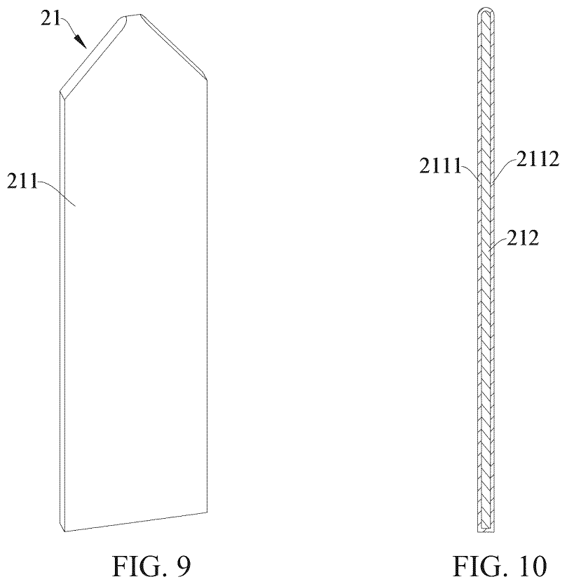

FIG. 9 and FIG. 10 show a heating device 21 according to a fourth modified embodiment of the present invention. The heating substrate 211 in this embodiment is in the shape of a flake. An end of the heating substrate 211 can be inserted into the atomizable medium 200 for heating. An other end of the heating substrate 211 may be inserted and fixed in the atomization base, and is mounted to the shell 10 through the atomization base. The heating substrate 211 has the first layer 2111 and the second layer 2112 arranged opposite to each other in a thickness direction thereof. The closed cavity 2110 is formed between the first layer 2111 and the second layer 2112.

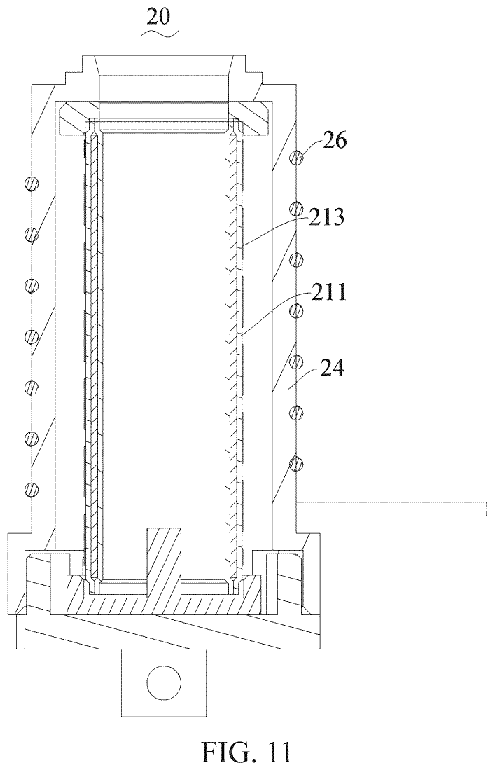

FIG. 11 shows an atomization assembly 20 according to another embodiment of the present invention. The atomization assembly 20 adopts a manner of composite heating, which includes a heating element 213 arranged on an inner wall surface and/or an outer wall surface of the heating substrate 211 and an electromagnetic coil 26 sleeved on a periphery of the heating substrate 211. The heating element 213 may include a resistive heating element and/or an infrared coating.

The electromagnetic coil 26 may be sleeved on the fixing tube 24 and configured to generate an electromagnetic field after being energized. In an embodiment, the heating substrate 211 includes a susceptor material or is made of a susceptor material. In another embodiment, a susceptor material may also be arranged in the atomizable medium 200. The term “susceptor material” is configured for describing a material that may convert electromagnetic energy into heat. When the susceptor material is located in the electromagnetic field, the electromagnetic field may generate an eddy current and/or a hysteresis loss in the susceptor material, causing the susceptor material to generate heat energy, thereby heating the atomizable medium 200.

It may be understood that the foregoing technical features may be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating device for heating an atomizable medium, the heating device comprising:
a heating substrate, at least one closed cavity being formed in the heating substrate; and
a vaporizable medium arranged in the at least one closed cavity.

2. The heating device of claim 1, wherein the at least one closed cavity comprises a vacuum cavity.

3. The heating device of claim 1, wherein the vaporizable medium comprises at least one of dowtherm, mercury, cesium, or sulfur.

4. The heating device of claim 1, further comprising:
a porous structure arranged in the at least one closed cavity.

5. The heating device of claim 4, wherein the porous structure comprises a microporous structure or a micro-slotted structure with a capillary force.

6. The heating device of claim 1, further comprising:
a protective film arranged on a surface of the heating substrate.

7. The heating device of claim 1, wherein the heating substrate comprises a first layer and a second layer arranged opposite to the first layer, and
wherein the closed cavity is formed between the first layer and the second layer.

8. The heating device of claim 1, wherein the heating substrate is in a shape of a tube, a flake, or a column.

9. The heating device of claim 1, further comprising:
a heating element arranged on a surface of the heating substrate.

10. An atomization assembly, comprising:
the heating device of claim 1; and
an atomization base arranged on an end of the heating device.

11. An aerosol generation device, comprising:
a shell; and
the atomization assembly of claim 10 arranged in the shell.
